(19) United States
(12) Patent Application Publication
(10) Pub. No.: US 2003/0010599 A1
(43) Pub. Date: Jan. 16, 2003

(54) Cleaning device

(76) Inventor: Magnus Svensson, Lund (SE)

Correspondence Address: Steven S. Payne, Law Office of Steven S. Payne, 8027 ILIFF Drive, Dunn Loring, VA, 22027, US

(21) Appl. No.: 10/157,139

(22) Filed: May 30, 2002

(30) Foreign Application Priority Data
Jun. 1, 2001 (SE) 0101945-4

(51) Int. Cl. G07F 1/04

(52) U.S. Cl. 194/347

(57) ABSTRACT

The present invention concerns a dirt separation module (1) for use at a coin sorting and/or counting machine (11). The module has an inlet (2) for coins (14) and a perforated plate (3). The perforated plate is received sliding in relation to the inlet (2) and is stepped. The invention also includes a CDS machine furnished with a dirt separation module (1). Furthermore, the invention concerns a method by which the plate is given a reciprocating movement to move the lowermost layer of coins (14) from the mass of coins.

### TECHNICAL FIELD

The present invention relates to a device for separating foreign objects from a mass of coins between a coin intake and a coin lifting device in a coin sorting and/or counting machine. The invention is specially directed to a so-called CDS-machine (Cash Deposit System).

### PRIOR ART

In existing coin sorting and/or counting machines there are several different principals known for separation of foreign objects. A combination of two or more solutions is common. The most common seems to be a combination of a perforated coin pan and a hopper that is possible to open.

A first known method is to use a rotating drum. Coins are led into a drum rotating around an axis. By using rails or inclination the coins are transported along the axis of rotation and falls out of the other end of the drum into a hopper. During the transportation the coins are influenced by rails and/or the geometry of the drum in a way to make the coins tumble about. The tumbling about is made in such a way that any dirt cannot slide on the coins without hitting the walls of the drum. These walls are perforated having openings that are smaller than the smallest coin, with the intention that the dirt will go through the holes and down into a collecting vessel. Larger objects are not separated but will fasten in the drum or pass through it.

In a second known method the coins are emptied together with dirt down into the hopper of the machine. The design of the hopper will only allow objects having characteristic features of coins to go on into the coin machine and unwanted objects are collected in the bottom part of the hopper. In order to get rid of the unwanted objects and dirt from the hopper, the hopper bowl will be moved from the hopper disc and the dirt will fall down into a collecting vessel. The movement of the hopper bowl may be manual or by means of an auxiliary motor.

In an alternative device to the above the dirt is to fall out of openings in the bottom of the hopper in stead of the hopper being divided. In order to have a more efficient separation of small, light particles a fan may blow down into the hopper and force the particles through the openings and out of the hopper. The dirt is collected in a collecting vessel.

In a further example the customer will empty his/her coins in a perforated coin pan. In order to get the coins down into the hopper the coin pan has to be lifted to an inclined position whereby the coins will move towards the open side of the coin pan. The size of the opening is adapted to hindering large objects from passing it and is that narrow that the coin pan has to be shaken, which means that small objects will be shaken down through the perforations and into a collecting vessel.

In still a further example a perforated plate is vibrated with high frequency to move the coins forward either by means of directed vibrations or by means of directed micro fibres on the plate. The intention is that dirt will fall down through the mass of coins as it is moved forward by the vibrations and vanish through the perforations of the plate.

In a last known alternative the coins are emptied into a stepped device. The coins will fall down the stepped device by means of gravity. The coins will bounce on a number of angled, perforated plates on the way down toward the hopper. The bouncing makes the coin tumble about and dirt may then hit the angled plates and pass through their perforations into one or more collecting vessels.

Even tough the above alternatives may function well in many instances they have some drawbacks. In rotating drums there is a risk that the coins will be squeezed and stuck at different plates. In alternatives having a vibration with high frequency the sound level may be somewhat high and also give rise to unwanted vibrations in the machine. Some alternatives does take up a rather large space and may be difficult to mount in existing machines.

### SUMMARY OF THE INVENTION

In a CDS there is a need for a fast, fail safe and compact apparatus separating dirt from the coins before they reach the unit lifting (hopper), counting and sorting them.

As stated above there is also a need for a dirt separation device not giving rise to unwanted vibrations and having a relatively low sound level.

The above objects are met by a dirt separation module having an inlet for coins and walls connected to or integrated with the inlet. The module has a perforated plate received sliding in relation to the walls and the inlet. Furthermore, the plate has a number of folds defined by creases.

The principal of the present invention is that coins are placed on the folded and perforated plate being oscillated in a linear movement in one plane. The folds of the plate function as the parts moving the coins forward and are formed in such a way that only the lowermost layer of coins is moved forward. The rest of the mass of coins are held stationary by the walls of the inlet. As only the lowermost layer is moved forces and stresses on the means of attachment are minimal. When unwanted objects hit the folds the perforations are placed in such a way that they are not moved forward but fall through the openings down into a collecting vessel.

Further objects and advantages of the present invention will be apparent for a person skilled in the art when reading the detailed description below of a preferred embodiment.

### BRIEF DESCRIPTION OF THE DRAWINGS

A preferred embodiment of the present invention will be described more closely below by way of an example and with reference to the enclosed drawings. In the drawings;

FIG. 1 is a view in perspective of a dirt separation module according to the present invention,

FIG. 2 is a cross-sectional view of the module of FIG. 1,

FIG. 3 is a plan view of a part of the module of FIGS. 1 and 2,

FIG. 4 is a sectional view taken along the lines IV-IV of FIG. 3,

FIG. 5 is a sketch showing the work principal of the module, and

FIG. 6 is a schematic, cut-out view in perspective of a machine showing the position of the dirt separation module according to the present invention.

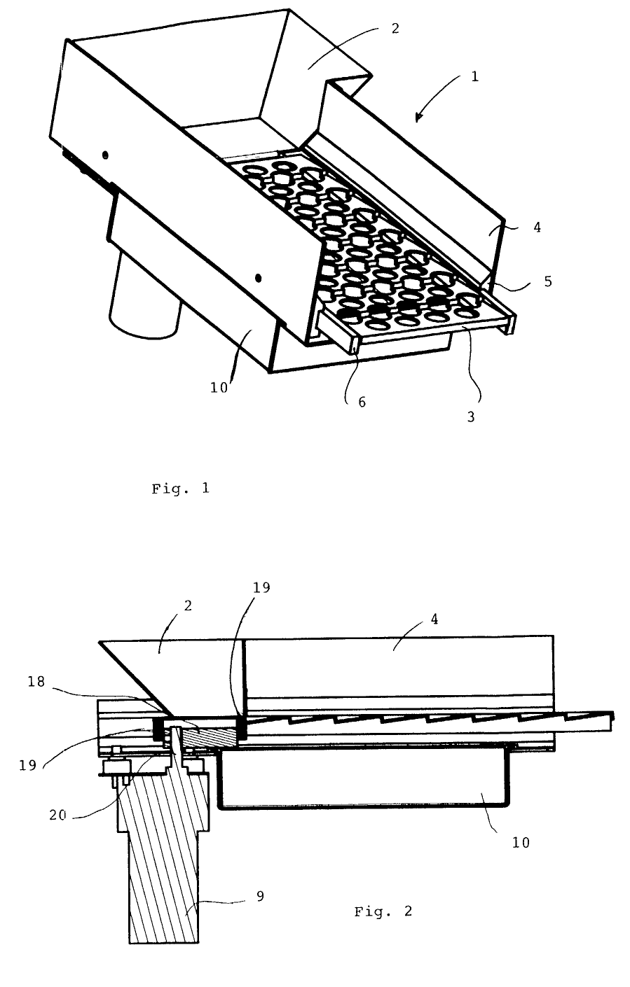

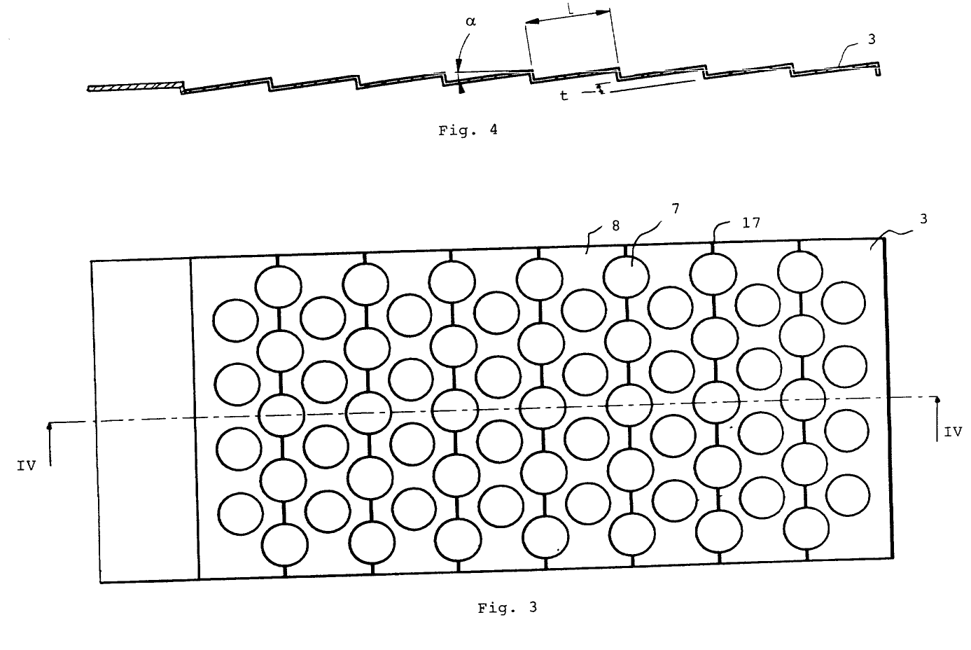

### DETAILED DESCRIPTION OF A PREFERRED EMBODIMENT

In the shown embodiment the dirt separation module 1 of the present invention comprises a coin inlet 2, a perforated plate 3, two walls 4, a motor 9 and a collecting vessel 10. The coin inlet 2 and the walls 4 are connected to form an open construction with no bottom for receiving the perforated plate 3. The perforated plate 3 has rails 6 at the sides facing the side walls 4, which rails 6 are received in guiding grooves 5 fixed to the side walls 4. By means of the rails 6 and the guiding grooves 5 the plate 3 is received sliding in relation to the walls 4. The perforated plate 3 extends all the way under the coin inlet 2 and the walls 4.

A person skilled in the art realises that the means permitting sliding of the plate 3 in relation to the walls 4 may have many different forms.

The module form makes it convenient to both insert and take out the module 1 in a machine, depending on customer demands, for maintenance etc.

The plate 3 has a number of perforations or openings 7 and a number of folds 8. As used in this description the expression “fold” relates to the area between two actual creases 17 of the plate 3. The plate 3 is placed generally plane in such a way that it forms a saw toothing seen from the side. The folds have a length L, a height t and an angle α to the horizontal plane. Thus, the plate 3 is stepped. A person skilled in the art realises that the plate 3 may be given a stepped form in many different ways. It is for instance possible to attach a number of smaller plates placed on top of each other at the ends in such a manner that they form a saw toothing seen from the side.

In the shown embodiment the openings 7 are placed in the same positions on the creases 17, but in other embodiments the openings 7 are displaced in relation to each other for two adjacent creases 17. The folds 8 of the plate should have a length L, which is bigger than half the diameter D of the largest coin 14. The height of the folds 8 is less or equal to the thickness of the thinnest coin 14. The height t and length L of the fold 8 gives the angle α, of the fold in relation to the horizontal plane. The openings 7 placed over the creases 17 forms an edge having a curve form for receiving separate coins 14.

Thus, the size of the folds 8 and the openings 7 are adjusted depending on the size of the largest and smallest expected coins 14. A person skilled in the art realises that said sizes may vary from country to country.

To the left (as shown in the Figs.) the plate 1 has a generally horizontal part that is received under the coin inlet 2. The length of said horizontal part and the amplitude of the movement to-and-fro are adapted in such a way, that in the turning point to the left the folded part of the plate 1 is placed under the inlet 2 and in the turning point to the right the horizontal part of the plate 1 is placed under the inlet 2.

At the inlet 2 a motor 9 is arranged having a camshaft 20 for driving the perforated, folded plate 3 to-and-fro. Thus, giving the plate 1 a reciprocating movement. A cam 18 driven by the camshaft 20 is placed between two running surfaces 19 of the plate 1. The running surfaces 19 are vertical walls fixed to or integrated with the plate 1. In other embodiments (not shown) the driving to-and-fro of the plate 3 is given by means of a linkage, solenoids or the like. The exact form for the driving is not critical as long as the plate is given a movement to-and-fro, having a low frequency and a high amplitude. The frequency is also adapted to the weight of the coins 14, the friction of the coins 14 both against each other and against the perforated plate 3 etc. As an example the amplitude is often set to about the same as the length L of one fold. The frequency is in one example set to 3.33 Hz. A person skilled in the art realises that the above stated values of amplitude and frequency are only examples and may be varied depending on the actual situation.

When a camshaft 20 is used, as in the shown embodiment, the dimensions of the cam control the amplitude of the movement of the plate 1. The frequency is given by controlling the speed of the motor.

To minimise the effects of the movement to-and-fro the module 1 may be supported in the machine by means of rubber mountings. In an alternative embodiment the camshaft 20 is balanced by means of counterweights. It is of course possible to combine the above measures. However, as the movement has a low frequency the problems with vibration transferred to the machine are relatively limited compared to movements having a high frequency.

A collecting vessel 10 is placed beneath the perforated plate 3 in order to collect separated particles of dirt. The collecting vessel 10 is placed on rails and may be taken out and emptied at any time.

In the shown embodiment the dirt separation module 1 is inserted in a coin sorting and/or counting machine 11. Said machine 11 is furnished with a coin tray 12 for receiving coins 14. From the dirt separation module 1 the coins are in normal way delivered to a standard hopper 13 of the coin separating and/or counting machine 1. In use the coins 14 are delivered to the inlet of the dirt separation module 1 in that the tray 12 is lifted in one end. As the tray 12 is lifted the coins 14 and possible dirt will fall into the inlet 2 of the dirt separation module 1. The module 1 may be installed in any machine, but as the machine as such forms no part of the present invention it will not be described further here.

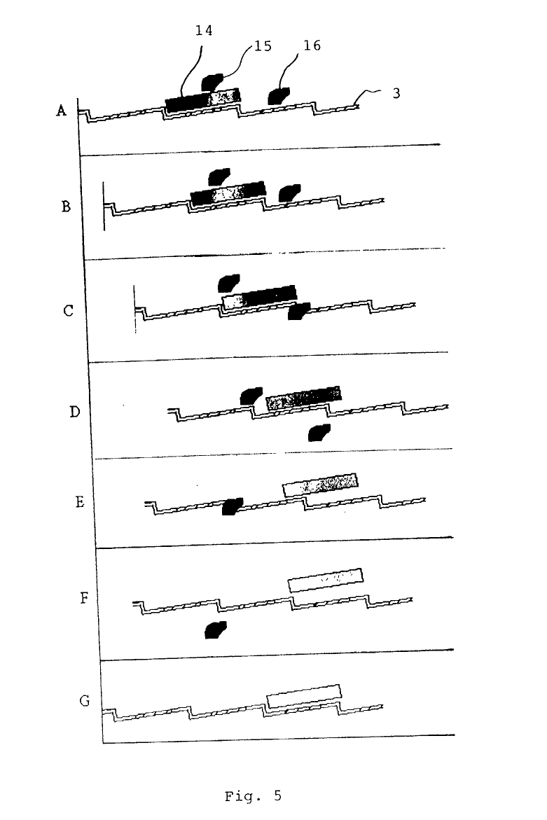

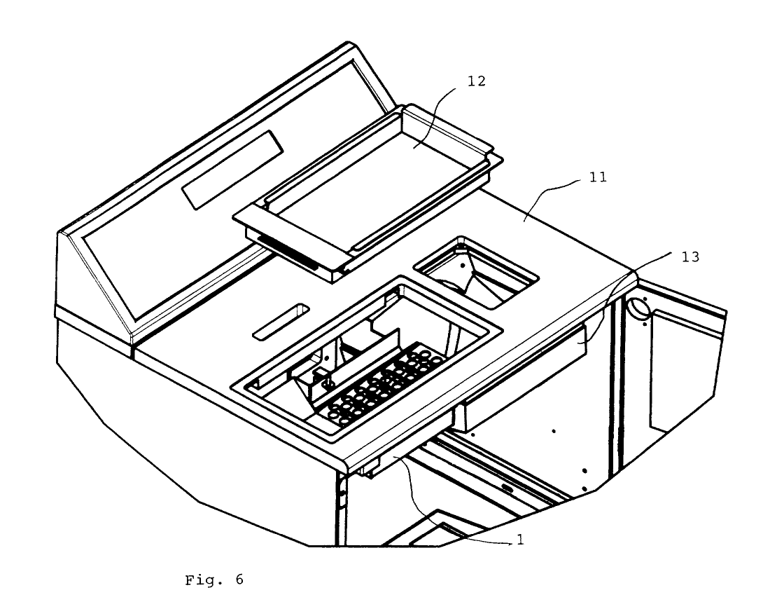

In FIG. 5 the operation of the dirt separation module 1 is shown schematically. In said operation the following steps may be observed:

A. The perforated plate 3 is in the rear turning point (to the left). On the plate 3 one coin 14 and two particles of dirt 15, 16 are shown.

B. The plate 3 move forward (to the right), whereby the crease 17 of the fold 8 press the coin 14 forward. The particles of dirt 15, 16 are not moved due to inherent inertia.

C. The plate 3 continues its movement forward and one of the particles of dirt 16 starts to fall into an opening 7.

D. The plate 3 has reached its forward turning point and one particle of dirt 16 is separated. The coin 14 continues to move forward due to the inherent inertia.

E. The plate 3 is moving back (to the left) and the other particle of dirt 15 starts to fall down trough an opening 7 in the plate 3. The coin 14 is not moving due to its inertia.

F. The plate 3 is moving further backwards and the last particle of dirt 15 is totally separated. The coin 14 is still not moving.

G. The plate 3 is back at the rear turning point and the coin 14 has fallen down onto the next fold 8 on the plate. Thus, the coin 14 has moved one fold further to the right compared to the position at step A.

Depending on the form and weight of the particles of dirt 15, 16 they may not move as much as shown in the Fig. It may happen that a particle of dirt does not leave the coin until the coin 14 has moved two or more folds 8 ahead. If the dirt is sticky it may adhere to the coin 14 and will not be separated.

The coins 14 may fall down on the plate in different positions and depending on the position of a specific coin 14 in relation to the openings 7 of the fold they may move somewhat to the side during the first cycles before they are completely received in an opening 7.

The purpose of the creases 17 of the folds 8 are to push only on the coin 14 and not on any dirt placed on the coin 14. The angle α and the length L of the folds 8 are adapted in such a way that only the lowermost layer of coins 14 will be moved. In order for the coins 14, e.g. if they are sticky, not to be transported on top of each other a separation rail or brush (not shown) may be placed a short distance above the moving plate 3. The separation rail or brush will also hinder large objects from passing through the separation module. When the coins has passed the dirt separation module 1, the separation rail is lifted and a guiding rail shifts position. At the same time a new vibration cycle is started, whereby the large objects are led down into the collecting vessel 10 by means of the guiding rail.

1. A dirt separation module (1) for use at a coin sorting and/or counting machine (11), which module (1) has an inlet (2) for coins (14), characterized in that a perforated plate (3) is received sliding in relation to the the inlet (2) and that the plate (3) is stepped.

2. The module of claim 1, characterized in that the plate (3) has a number of folds (8) defined by creases (17), that the plate (3) has a generally horizontal orientation and that the plate (1) has a horizontal part having no openings placed in the region of the coin inlet (2).

3. The module of claim 2, characterized in that the plate (3) has rails (6) on two sides, which rails (6) are to co-operate with guiding grooves (5) or the like, whereby the plate (3) is sliding in relation to the inlet (2) and that a collecting vessel (10) is placed under the plate (3).

4. The module of claim 3, characterized in that means are provided to move the plate (3) to-and-fro.

5. The module of claim 4, characterized in that the means for moving the plate (3) is a cam (18) driven by a motor (9) by means of a camshaft (20), which cam (18) are received between two vertical running surfaces (19) fixed to or integrated with the plate (3)and
that the size of the cam (18) and the frequency of the motor (9) is set to give a movement to-and-fro for the plate (3) having a large amplitude and a low frequency.

6. The module of claim 4, characterized in that the means for moving the plate (3) is a linkage or one or more solenoids.

7. The module of any of the previous claims, characterized in that the module (1) is supported by means of rubber mountings and/or that counterweights are arranged at the camshaft (20) to balance it.

8. The module of any of the claims 2 to 7, characterized in that the folds (8) are given a length (L) and angle (α) in relation to a horizontal plane which are adapted to the coins to be sorted and/or counted.

9. The module of claim 8, characterized in that the length (L) of one fold (8) is somewhat larger than half the diameter of the largest expected coin (14) and that the angle (α) is such that the height (t) of a crease (17) is somewhat less than the thickness of the thinnest expected coin (14).

10. The module of any of the previous claims, characterized in that the diameter of the openings (7) of the perforated plate (3) are somewhat smaller than the diameter of the smallest expected coin (14).

11. The module of any of the claims 4 to 10, characterized in that in one turning point for the plate (3) the horizontal part of the plate (3) is placed under the coin inlet (2), while in the other turning point a part of the plate (3) having folds (8) is placed under the inlet (2).

12. A CDS machine, characterized in that is furnished with a dirt separation module according to any of the above claims.

13. A method of separating dirt from a mass of coins (14.) in a coin sorting and/or counting machine (11), which mass of coins (14) are received in an inlet (2) characterized in that a lowermost layer of coins of the mass of coins (14) are moved out by means of a reciprocating movement given to a plate (3) having a number of openings (7) through which the dirt is transferred.

14. The method of claim 13, characterized in that the upper part of the mass of coins (14) is kept stationary.

15. The method of claim 13 or 14, characterized in that the coins in the lowermost layer is thrown forward by the reciprocating movement and are hindered from going backwards.

16. The method of any of the claims 13 to 15, characterized in that one layer of coins (14) are transported one at the time from the mass of coins (14).
